(19) United States
(12) Patent Application Publication
(10) Pub. No.: US 2007/0130788 A1
(43) Pub. Date: Jun. 14, 2007

(54) Wood drying method and apparatus

(75) Inventor: Hirofumi Kunugi, Aichi (JP)

Correspondence Address: ROSSI, KIMMS & McDOWELL LLP., P.O. BOX 826, ASHBURN, VA, 20146-0826, US

(73) Assignee: HASEBE CO., LTD, Tokyo (JP)

(21) Appl. No.: 10/574,754

(22) PCT Filed: Oct. 7, 2004
(86) PCT No.: PCT/JP04/14849

§ 371 Date: Aug. 14, 2006

(30) Foreign Application Priority Data
Oct. 8, 2003 (JP) 2003-349421

(51) Int. Cl. F26B 25/06; F26B 7/00

(52) U.S. Cl. 34/202; 34/396

(57) ABSTRACT

Wood (1) is coated with a material of good heat conductance and heat resistance, such as an aluminum foil (2), and then placed in a drying kiln (3), where it is dried in an environment of high temperature (e.g., 200 degrees C.) not exceeding an ignition temperature. Because the drying process progresses with the wood substantially braised at high temperature, the wood can be dried virtually uniformly throughout both its surface and interior. Consequently, it is possible to completely, or almost completely, avoid the wood from cracking from the surface and also prevent deformations, such as a warp, bend, etc., of the wood. Further, because the wood can be dried in an environment of considerably high temperature, a necessary drying time can be significantly reduced.

### TECHNICAL FIELD

The present invention relates to methods and apparatus for seasoning or drying wood, and more particularly to a technique suited to dry wood directly in raw log form at high speed in a high-temperature environment.

### BACKGROUND ART

The so-called “medium-temperature drying method” is a mainstream of the various conventional wood drying methods for drying wood in artificial heating environments. According to the medium-temperature drying method, raw wood is cut into a size greater than a desired lumber product size and lumbered, then placed in a drying chamber in naked or directly exposed condition and thence dried in a medium-temperature heating environment of approximately 80 degrees C. (Centigrade or Celsius) for a relatively long period of time, e.g. a few weeks. The reason why the wood is dried at a medium temperature of about 80 degreed C. is that, if dried in a heating environment higher than about 90 degrees C., cracking would be produced in the dried wood such that the dried wood can not be used as a lumber product. However, such medium-temperature heating would take a few weeks (e.g., two weeks) of drying and thus is unable to perform high-speed drying. Further, the reason why the wood is dried in a size greater than a desired lumber product size is that the drying would unavoidably produce deformations, such as a warp, bend, etc. in the wood and thus the wood has to be cut in it peripheral regions where the warp, bend, etc. have occurred and then re-sawn into the desired lumber product size. Therefore, the yield of the lumber product tends to be very poor. Further, because such re-sawing is required, the “medium-temperature heating method” can not be applied properly to provide a lumber product of an appropriate size from raw wood of a relatively small trunk diameter. Among examples of such raw wood having a relatively small trunk diameter is larchwood. Larchwood in particular would present a problem that so-call “disorder”, such as a great torsion, warp and crack, occurs when dried. For these reasons, the conventional technique can not appropriately dry larchwood in an artificial manner; thus, it has heretofore been impossible to widely distribute larchwood as industrial lumber for extensive use.

Also, there has been used the “high-temperature drying method” that is intended to reduce the necessary drying time period by drying at high temperature. The high-temperature drying method comprises exposing wood to high-frequency radiation so as to dry the wood in a heating environment at a relatively high temperature in a range from about 100 degrees C. to 150 degrees C. However, even the high-temperature drying would require a relatively long drying time. Further, the high-temperature drying for a long time could undesirably change the surface of the wood into a blackish brown color, resulting in deteriorated quality of the wood. Furthermore, even with the high-temperature drying method, deformations, such as a warp, bend, etc., would unavoidably occur in the wood as a result of the drying; thus, after the drying, it has been necessary to cut the wood in its peripheral regions where the warp, bend, etc. have occurred and then re-saw the wood into a desired lumber product size. Fore these reasons, the high-temperature drying method too presents the problem that the yield of the lumber product is very poor. Needless to say, the high-temperature drying method too is unsuited for drying of wood, such as larchwood, having a relatively small trunk diameter.

### SUMMARY OF THE INVENTION

In view of the foregoing, it is an object of the preset invention to provide a wood drying method and apparatus which can dry wood at high speed and in a high-temperature environment while effectively preventing (or minimizing) deformations, such as a warp, bend, etc. of the wood. It is another object of the preset invention to provide a wood drying method and apparatus which are suited for drying wood directly in raw log form at high speed in a high-temperature environment.

The present invention provides a wood drying method characterized in that wood coated with a material of good heat conductance and heat resistance is placed in a high-temperature environment not exceeding an ignition temperature and then dried in the high-temperature environment. In a preferred embodiment, the material of good heat conductance and heat resistance is a metal foil. Preferably, the metal foil is an aluminum foil.

According to the present invention, the wood to be dried is coated with a material of good heat conductance and heat resistance, such as an aluminum or other metal foil as stated above. Thus, even if the wood is exposed to the high-temperature environment not exceeding the ignition temperature, no scorch and/or the like could occur in the surface of the wood. Further, the coating can prevent the wood from drying starting from the surface. Namely, because the wood is coated with a material of good heat conductance and heat resistance (such as an aluminum or other metal foil), the drying process progresses with the wood substantially braised at high temperature so that the wood can be dried virtually uniformly throughout both the surface and the interior thereof; consequently, the present invention can effectively avoid the wood from cracking from the surface and can also prevent deformations, such as a warp, bend, etc., of the wood. Further, because the wood can be dried in the environment of considerably high temperature of about 200 degrees C., which was not used in the past, the necessary drying time period can be significantly reduced. Furthermore, since the present invention can completely, or almost completely, avoid the wood from cracking from the surface, the wood may be directly dried in raw log form and may be subjected to a necessary lumbering process only after the drying; as a result, the present invention can eliminate the need for re-sawing of the wood and can significantly improve the yield in the industrial lumbering. Therefore, the present invention is suited to artificial drying of wood, such as larchwood, having a relatively small trunk diameter, and it also allows thinned wood, which heretofore has not been so usable, to be advantageously provided for industrial lumbering.

### BRIEF DESCRIPTION OF DRAWINGS

FIG. 1 is a schematic view explanatory of a wood drying method and apparatus according to an embodiment of the present invention.

### BEST MODE FOR CARRYING OUT THE INVENTION

Detailed description will hereinafter be given about the embodiment of the present invention.

In a first step of the wood drying method of the present invention, elongated wood 1 to be dried is coated on its outer peripheral surface with an aluminum foil 2. This coating operation can be performed manually by a human operator, but may of course be mechanized as necessary. The aluminum foil 2, which is selected here as a coating material of good heat conductance and good heat resistance, can easily conduct an externally-applied high heat to the wood 1 coated therewith (good heat conductance) but is not in itself easily burnable (good heat resistance). Therefore, the material (2) coating the wood 1 may be any other metal foil than the aluminum foil 2 or any other suitable material as long as it has good heat conductance and good heat resistance. Note that, if the aluminum foil 2 is of a size having a limited width and a sufficient length, then the aluminum foil 2 may be wound spirally on the outer periphery of the wood 1, as illustrated in the figure, to coat the entire outer peripheral surface of the wood 1. In the illustrated example, the entire outer cylindrical surface of the wood 1 is coated with the aluminum foil 2 without the opposite end surfaces 1a of the wood 1 being coated with the aluminum foil 2. Alternatively, the entire outer surface, i.e. both the outer cylindrical surface and the end surfaces, of the wood 1 may be coated with the aluminum foil 2. Of course, the aluminum foil 2, i.e. coating material, may be of any desired thickness. Further, if there is a possibility of the coating material being broken due to its small thickness, the wood 1 may be coated with the aluminum foil 2 twofold or multifold. Further, the wood 1 to be dried (i.e., the wood to be coated with the aluminum foil 2 or coating material) may be in the form of a raw log (i.e., log obtained by peeling the skin of raw wood). However, if, for example, the raw log is too big to handle, the raw log may be cut into a suitable size and then used as the wood 1 (i.e., the wood to be coated with the aluminum foil 2 or coating material). Note that, as necessary, the raw log may be subjected to radial saw-cut/back-slit processing in advance to prevent cracking due to drying, and the thus-processed log 1 may be coated on its outer peripheral surface with the aluminum foil 2 or coating material.

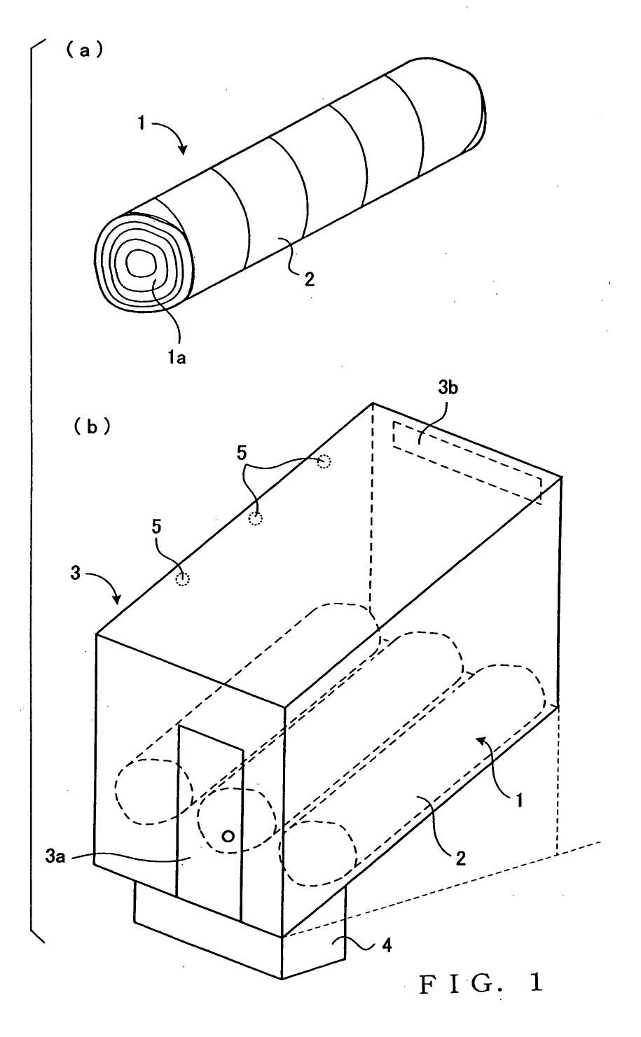

In a second step of the wood drying method of the present invention, the wood 1 coated with the aluminum foil 2 is introduced into a drying kiln (drying device) 3 as illustrated in section (b) of FIG. 1, and placed in and exposed to a high-temperature environment, not exceeding an ignition temperature, for desired drying of the wood 1. The drying kiln 3 includes a furnace chamber slanted as appropriate to provide, for example, an ascending kiln, and it has a door 3a formed at or near the lower end of the slanted furnace chamber for taking the wood 1 in or out of the furnace chamber, and an exhaust hole 3b at or near the upper end of the slanted furnace chamber. The drying kiln 3 also includes a heating furnace 4 at its bottom near the lower end of the slanted furnace chamber. Heat source of the heating furnace 4 may be provided by burning an appropriate burnable substance primarily comprising, for example, skins (waste skins) peeled from the surface of raw wood. Alternatively, the heat source may be electric heat or any other suitable means; for example, the heating furnace 4 may include a high-frequency drying means or the like. At appropriate locations of the drying kiln 3, there are disposed a plurality of temperature measuring devices 5 for monitoring a temperature within the kiln. Amount of heat generation by the heating furnace 4 is controlled on the basis of the monitored temperature within the kiln 3, in order to maintain an appropriate high-temperature environment not exceeding the ignition temperature. In this case, the control of the burning (heat generation) amount based on the measured temperature may be performed either in an automatic manner or manually by a human operator. Alarm device may be provided for issuing a predetermined alarm, in the form of sound or light display, when the temperature within the kiln has reached a critical high temperature below the ignition temperature, in the case where the control of the burning (heat generation) amount is controlled manually (or automatically). Of course, the present invention can be implemented with no inconvenience, even if the high temperature of about 200 degrees C. can not be maintained; namely, even in case the temperature within the kiln 3 falls for some reason related to the operation or temperature control, the present invention can be implemented with no inconvenience. Note that pressure within the drying kiln 3 may be equal to the ambient air pressure; however, a reduced-pressure drying method may be combined as necessary.

Generally, the ignition temperature of wood is approximately 237 degrees C. Thus, the present invention may be arranged to dry the wood 1 in a high-temperature environment of about 200 degrees C. that does not exceed the ignition temperature of the wood. It has been confirmed experimentally that even a log having a diameter in the order of 30 cm can be dried to a moisture content of about 10% by drying the log for a time period of only about three or four days using the drying method of the present invention. Therefore, it can be seen that the drying method of the present invention is significantly efficient in view of the fact that the conventional artificial wood drying methods, requiring a much longer drying time of a few weeks, can only achieve a moisture content of about 18% at best. The moisture or water in the wood 1 drips out, during the drying process, mainly through the ends 1a of the wood 1. Portion of the water, dripping out of the wood 1 and accumulating in a bottom portion of the aluminum foil 2 coating the bottom end of the wood 1, is discarded directly when the aluminum foil coating is removed from the wood 1.

According to the present invention as set forth above, the wood 1 to be dried is coated (or wrapped) with a material of good heat conductance and heat resistance, such as the aluminum foil 2. Thus, even if the wood 1 is exposed to a high-temperature environment of about 200 degrees C. that is lower than, but close to, the ignition temperature, no unwanted scorch, color change and/or the like could occur in the surface of the wood, so that quality deterioration of the wood 1 is effectively prevented. Further, the coating can prevent the wood 1 from drying starting from the surface. Namely, because the wood 1 is coated (or wrapped) with a material of good heat conductance and heat resistance, such as the aluminum foil 2, the drying process progresses with the wood 1 substantially braised at high temperature so that the wood 1 can be dried virtually uniformly throughout both the surface and interior thereof; consequently, the present invention can completely, or almost completely, avoid the wood 1 from cracking from the surface and can also prevent deformations, such as a warp, bend, etc., of the wood 1. Further, because the wood 1 is dried in an environment of considerably high temperature, e.g. about 200 degrees C. which was not used in the past, the present invention requires a drying time of only about three or four days that is much shorter than that required by the conventional method. Furthermore, because the present invention can completely, or almost completely, avoid the wood 1 from cracking from the surface, the wood may be dried in raw log form and may be subjected to the lumbering process only after the drying; as a result, the present invention can eliminate the need for re-sawing of the wood and can significantly improve the yield in the industrial lumbering. Therefore, the present invention is suited to artificial drying of wood, such as larchwood or thinned wood, having a relatively small trunk diameter, not to mention direct drying of a log having a great diameter. Particularly, if larchwood is dried directly in log form in accordance with the present invention, “disorder”, crack, warp, bend, etc. of the larchwood can be avoided almost completely, so that the dried larchwood can be advantageously provided for industrial lumbering. Furthermore, the present invention allows thinned wood, which heretofore has not been so usable, to be advantageously provided for industrial lumbering.

1. A wood drying method characterized in that wood coated with a material of good heat conductance and heat resistance is placed in a high-temperature environment not exceeding an ignition temperature and then dried in the high-temperature environment.

2. A wood drying method as claimed in claim 1 wherein said material of good heat conductance and heat resistance is a metal foil.

3. A wood drying method as claimed in claim 2 wherein said metal foil is an aluminum foil.

4. A wood drying method as claimed in claim 1 wherein said wood is a log.

5. A wood drying method as claimed in claim 1 wherein said wood is placed in the high-temperature environment with an entire surface, except for end surfaces, of said wood coated with the material.

6. A wood drying apparatus characterized in that wood coated with a material of good heat conductance and heat resistance is placed in a high-temperature environment not exceeding an ignition temperature and then dried in the high-temperature environment.

7. A wood drying apparatus as claimed in claim 6 wherein said material of good heat conductance and heat resistance is a metal foil.

8. A wood drying apparatus as claimed in claim 7 wherein said metal foil is an aluminum foil.

9. A wood drying apparatus as claimed in claim 6 wherein said wood is a log.

10. A wood drying apparatus as claimed in claim 6 wherein said wood is placed in the high-temperature environment with an entire surface, except for end surfaces, of said wood coated with the material.
